(19) United States
(12) Patent Application Publication
(10) Pub. No.: US 2026/0247277 A1
(43) Pub. Date: Aug. 20, 2026

(54) METHOD, ACCESS NETWORK NODE AND USER EQUIPMENT

(71) Applicant: Maxime GRAU, London (GB)

(72) Inventor: Maxime GRAU, London (GB)

(21) Appl. No.: 18/852,563

(22) PCT Filed: Apr. 10, 2023
(86) PCT No.: PCT/JP2023/014636

§ 371 Date: Sep. 30, 2024

(30) Foreign Application Priority Data
Apr. 26, 2022 (GB) 2206088.3

(51) Int. Cl. H04W 52/02; H04W 36/00; H04W 72/1263

(52) U.S. Cl. CPC H04W 52/0206; H04W 36/0072; H04W 72/1263

(57) ABSTRACT

A system is disclosed in which a base station (5) transmits, to a user equipment (UE) (3), first information indicating, for each one of a plurality of blocks of consecutive subframes within a period, whether an energy saving operation is applied.

### TECHNICAL FIELD

The present disclosure relates to a wireless communication system and devices thereof operating according to the 3rd Generation Partnership Project (3GPP) standards or equivalents or derivatives thereof. The disclosure has particular but not exclusive relevance to energy saving techniques in the so-called ‘5G’ or ‘New Radio’ systems (also referred to as ‘Next Generation’ systems) and similar systems.

### BACKGROUND ART

Under the 3GPP standards, a NodeB (or an ‘eNB’ in LTE, ‘gNB’ in 5G) is a base station via which communication devices (user equipment or ‘UE’) connect to a core network and communicate to other communication devices or remote servers. Communication between the UEs and the base station is controlled using the so-called Radio Resource Control (RRC) protocol. Communication devices might be, for example, mobile communication devices such as mobile telephones, smartphones, smart watches, personal digital assistants, laptop/tablet computers, web browsers, e-book readers, and/or the like. Such mobile (or even generally stationary) devices are typically operated by a user (and hence they are often collectively referred to as user equipment, ‘UE’) although it is also possible to connect Internet of Things (IoT) devices and similar Machine Type Communications (MTC) devices to the network. For simplicity, the present application will use the term base station to refer to any such base stations and use the term mobile device or UE to refer to any such communication device.

The latest developments of the 3GPP standards are the so-called ‘5G’ or ‘New Radio’ (NR) standards which refer to an evolving communication technology that is expected to support a variety of applications and services such as MTC/IoT communications, vehicular communications and autonomous cars, high resolution video streaming, smart city services, and/or the like. 3GPP intends to support 5G by way of the so-called 3GPP Next Generation (NextGen) radio access network (RAN) and the 3GPP NextGen core (NGC) network. Various details of 5G networks are described in, for example, the ‘NGMN 5G White Paper’ V1.0 by the Next Generation Mobile Networks (NGMN) Alliance, which document is available from https://www.ngmn.org/5g-white-paper.html.

End-user communication devices are commonly referred to as User Equipment (UE) which may be operated by a human or comprise automated (MTC/IoT) devices. Whilst a base station of a 5G/NR communication system is commonly referred to as a New Radio Base Station (‘NR-BS’) or as a ‘gNB’ it will be appreciated that they may be referred to using the term ‘eNB’ (or 5G/NR eNB) which is more typically associated with Long Term Evolution (LTE) base stations (also commonly referred to as ‘4G’ base stations). 3GPP Technical Specification (TS) 38.300 V16.7.0 and 3GPP TS 37.340 V16.7.0 define the following nodes, amongst others:

gNB: node providing NR user plane and control plane protocol terminations towards the UE, and connected via the NG interface to the 5G core network (5GC).

ng-eNB: node providing Evolved Universal Terrestrial Radio Access (E-UTRA) user plane and control plane protocol terminations towards the UE, and connected via the NG interface to the 5GC.

En-gNB: node providing NR user plane and control plane protocol terminations towards the UE, and acting as Secondary Node in E-UTRA-NR Dual Connectivity (EN-DC).

NG-RAN node: either a gNB or an ng-eNB.

The term base station or RAN node is used herein to refer to any such node.

Energy consumption of base stations and other similar access network nodes represents a major operational expenditure for network operators. There are various tools to save energy at the network side. For example, capacity cells (i.e. cells that are deployed for assisting certain areas in peak times) can be switched off and neighbouring cells are aware of whether the capacity cell is available or not. This function allows, for example in a deployment where capacity boosters can be distinguished from cells providing basic coverage, to optimise energy consumption enabling the possibility for an E-UTRA cell or an E-UTRA-New Radio Dual Connectivity (EN-DC) cell providing additional capacity via single or dual connectivity, to be switched off when its capacity is no longer needed and to be re-activated on a need basis. The decision is typically based on cell load information, consistently with configured information. The switch-off decision may also be taken by Operations and Maintenance (O&M).

The base station may initiate handover actions in order to off-load the cell being switched off and may indicate the reason for handover with an appropriate cause value to support the target node in taking subsequent actions, e.g. when selecting the target cell for subsequent handovers. The configured information typically includes the ability of a base station to perform autonomous cell switch-off, and the ability of a base station to request the re-activation of a configured list of dormant cells owned by a peer base station. O&M may also configure policies used by the base station for cell switch-off decision, and policies used by peer base stations for requesting the re-activation of a dormant cell.

From a physical point of view, if at least one channel is active, the cell is on and consumes most of its power. Any additional channel represents a marginal power consumption increase so having the cell either completely on using ~100% of its capacity or completely off is preferable from network energy saving perspective.

### SUMMARY OF INVENTION

### Technical Problem

In general, the network can decide to switch off an entire cell if the load is not enough and UEs can be offloaded to neighbouring cells. However this may not always be feasible, e.g. for coverage cells if no other cell is available (as the network still has to ensure service to UEs). Moreover, in some cases switching off an entire cell would result in neighbouring cells using more power (to enhance their coverage) than it would save for the cell being switched off. It would also cause some overhead signalling related to handover of UEs to a suitable neighbour cell.

There are other methods to save energy at the network (base station), for example:
saving spectrum: not transmitting over full bandwidth (the base station uses only a part of its available spectrum by managing bandwidth parts);
saving covered space: not transmitting power in some areas of the cell coverage;
saving power: transmitting at lower power (which effectively reduces cell coverage and/or throughput); and
saving time: not transmitting during certain periods of time (in this case the network can configure long periodicity for signalling channels, e.g. up to every 160 ms for SSS/PSS, MIB, and PRACH).

In more detail, certain functions may be “turned off” independently for relatively short periods of time:
Synchronisation signals (Primary Synchronization Signal (PSS) and Secondary Synchronization Signal (SSS)) and the Master Information Block (MIB) are transmitted with periodicity of 5 ms, 10 ms, 20 ms, 40 ms, 80 ms or 160 ms;
System Information Block Type 1 (SIB1) is broadcast with a periodicity of 160 ms and variable transmission repetition periodicity within 160 ms;
The other SIBs can be broadcast with different periodicity indicated by SIB1 every 8, 16, 32, 64, 128, 256 or 512 radio frames (1 radio frame=10 ms);
Physical Random Access Channel (PRACH) can be configured from every 1 ms to once per 160 ms; and
Control and Data channels can be configured by the base station on a per-UE basis so depending on UE traffic requirements there can be periods of time with no uplink (UL) or downlink (DL) transmission in the cell of the base station.

Hence, it is possible in legacy system to virtually switch-off the cell for up to 160 ms by limiting the broadcast of signalling channels and configuring data resources around the time when the cell is on and transmitting said channels. However, this approach is not flexible since it is limited by the PSS/SSS periodicity used and the PRACH across 16 radio frames (160 ms) and it does not offer fine granularity.

The network can schedule UL and DL resources to be at the same time and not transmit/receive data the rest of the time to achieve some energy savings. The network can also adjust the coverage of a cell by increasing/decreasing transmit power. If appropriate, load balancing may be performed between neighbouring cells with handover or dual connectivity.

However, the existing solutions do not provide dynamic sleep patterns (on/off patterns) as cell switch-off is a one-off procedure. Moreover, the network can only periodically switch off signalling, not data transmissions.

Using these legacy methods the cell is completely switched off, which means that the cell ‘disappears’ completely (i.e. it becomes unavailable to all UEs), typically for a very long time, e.g. overnight. Accordingly, UEs must be redirected to another cell so this is only applicable to capacity cells, i.e. not possible for coverage cells. It is not possible to configure a UE to automatically (or in a planned manner) return to the cell since any redirected UE can return to the cell only via legacy cell reselection when the cell appears again.

From Release 18, a new type of system information may be used for more flexible cell sleep patterns (e.g. “micro-sleep”). It is also envisaged to allow UE triggered base station wake-up and provide UE assistance for network energy saving in general. 3GPP intends to prioritise idle/empty and low/medium load scenarios (the exact definition of such loads is not yet agreed upon).

Thus, there is a need to achieve a more efficient energy saving operation through dynamic and/or semi-static and finer granularity adaptation of transmissions and/or receptions by the base stations, in one or more of network energy saving techniques in time, frequency, spatial, and power domains, with potential support/feedback from UEs.

### Solution to Problem

Accordingly, the present disclosure seeks to provide methods and associated apparatus that address or at least alleviate (at least some of) the above-described issues.

In one aspect, the disclosure provides a method performed by an access network node, the method comprising: transmitting, to a user equipment (UE), first information indicating, for each one of a plurality of blocks of consecutive subframes within a period, whether an energy saving operation is applied by the access network node for the one of the plurality of blocks of the consecutive subframes.

In one aspect, the disclosure provides a method performed by a user equipment (UE), the method comprising: receiving, form an access network node, first information indicating, for each one of a plurality of blocks of consecutive subframes within a period, whether an energy saving operation is applied by the access network node for the one of the plurality of blocks of the consecutive subframes.

In one aspect, the disclosure provides an access network node comprising: means (for example a memory, a controller, and a transceiver) for transmitting, to a user equipment (UE), first information indicating, for each one of a plurality of blocks of consecutive subframes within a period, whether an energy saving operation is applied by the access network node for the one of the plurality of blocks of the consecutive subframes.

In one aspect, the disclosure provides a user equipment (UE) comprising: means (for example a memory, a controller, and a transceiver) for receiving, form an access network node, first information indicating, for each one of a plurality of blocks of consecutive subframes within a period, whether an energy saving operation is applied by the access network node for the one of the plurality of blocks of the consecutive subframes.

Aspects of the disclosure extend to corresponding systems, apparatus, and computer program products such as computer readable storage media having instructions stored thereon which are operable to program a programmable processor to carry out a method as described in the aspects and possibilities set out above or recited in the claims and/or to program a suitably adapted computer to provide the apparatus recited in any of the claims.

Although for efficiency of understanding for those of skill in the art, the disclosure will be described in detail in the context of a 3GPP system (5G networks), the principles of the disclosure can be applied to other systems as well.

The present disclosure is defined by the claims appended hereto. Aspects of the disclosure are as set out in the independent claims. Some optional features are set out in the dependent claims.

However, each feature disclosed in this specification (which term includes the claims) and/or shown in the drawings may be incorporated in the disclosure independently of (or in combination with) any other disclosed and/or illustrated features. In particular but without limitation the features of any of the claims dependent from a particular independent claim may be introduced into that independent claim in any combination or individually.

### BRIEF DESCRIPTION OF DRAWINGS

Embodiments of the disclosure will now be described, by way of example, with reference to the accompanying drawings in which:

FIG. 1 illustrates schematically a mobile (cellular or wireless) telecommunication system to which embodiments of the disclosure may be applied;

FIG. 2 is a schematic block diagram of a mobile device forming part of the system shown in FIG. 1;

FIG. 3 is a schematic block diagram of an access network node (e.g. base station) forming part of the system shown in FIG. 1;

FIG. 4 is a schematic block diagram of a core network node forming part of the system shown in FIG. 1;

FIG. 5 is schematic signalling (timing) diagram illustrating the exemplary way in which network energy saving may be realised in the system shown in FIG. 1;

FIG. 6 is schematic signalling (timing) diagram illustrating the exemplary way in which network energy saving may be realised in the system shown in FIG. 1;

FIG. 7 is schematic signalling (timing) diagram illustrating the exemplary way in which network energy saving may be realised in the system shown in FIG. 1; and

FIG. 8 is schematic signalling (timing) diagram illustrating the exemplary way in which network energy saving may be realised in the system shown in FIG. 1.

### DESCRIPTION OF EMBODIMENTS

### Overview

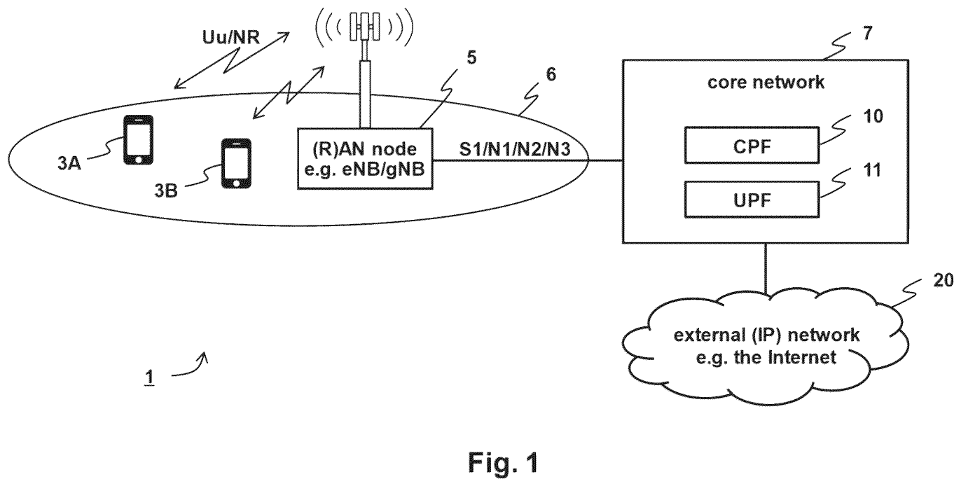

FIG. 1 illustrates schematically a mobile (cellular or wireless) telecommunication system 1 to which embodiments of the disclosure may be applied.

In this system 1, users of mobile devices 3 (UEs) can communicate with each other and other users via base stations 5 (and other access network nodes) and a core network 7 using an appropriate 3GPP radio access technology (RAT), for example, an Evolved Universal Terrestrial Radio Access (E-UTRA) and/or a 5G RAT. It will be appreciated that a number of base stations 5 form a (radio) access network or (R)AN. As those skilled in the art will appreciate, whilst two mobile devices 3A and 3B and one base station 5 are shown in FIG. 1 for illustration purposes, the system, when implemented, will typically include other base stations/(R)AN nodes and mobile devices (UEs).

Each base station 5 controls one or more associated cell 6 (either directly or via other nodes such as home base stations, relays, remote radio heads, distributed units, and/or the like). A base station 5 that supports Next Generation/5G protocols may be referred to as a ‘gNBs’. It will be appreciated that some base stations 5 may be configured to support both 4G and 5G, and/or any other 3GPP or non-3GPP communication protocols.

The mobile device 3 and its serving base station 5 are connected via an appropriate air interface (for example the so-called ‘NR’ air interface, the ‘Uu’ interface, and/or the like). Neighbouring base stations 5 are connected to each other via an appropriate base station to base station interface (such as the so-called ‘Xn’ interface, the ‘X2’ interface, and/or the like). The base stations 5 are also connected to the core network nodes via an appropriate interface (such as the so-called ‘NG-U’ interface (for user-plane), the so-called ‘NG-C’ interface (for control-plane), and/or the like).

The core network 7 (e.g. the EPC in case of LTE or the NGC in case of NR/5G) typically includes logical nodes (or ‘functions’) for supporting communication in the telecommunication system 1, and for subscriber management, mobility management, charging, security, call/session management (amongst others). For example, the core network 7 of a ‘Next Generation’/5G system will include user plane entities and control plane entities, such as one or more control plane functions (CPFs) 10 and one or more user plane functions (UPFs) 11. For example, the so-called Access and Mobility Management Function (AMF) in 5G, or the Mobility Management Entity (MME) in 4G, is responsible for handling connection and mobility management tasks for the mobile devices 3, and the Session Management Function (SMF) is responsible for handling communication sessions for the mobile devices 3 such as session establishment, modification and release. The core network 7 is coupled (via the UPF 11) to a data network 20, such as the Internet or a similar Internet Protocol (IP) based network.

In this system 1, UE-assisted network energy savings are realised based on one or more of the following features:
A parameter that indicates an energy saving (ES) configuration used by the base station 5. The ES configuration includes at least one of:
   a mapping over a period of time with a certain granularity of on/off times (e.g. 32 bits may be used for a granularity of five subframes over a 160 ms period); and
   an indication of the affected functionalities to be turned on/off (including e.g. synchronisation signals, MIB, SIBs, PRACH, configured grants, retransmissions, scheduled PUSCH/PDSCH transmissions).
The ES configuration is transmitted to the UEs 3 in an RRC message (e.g. RRC Reconfiguration/RRC Connection Reconfiguration message) or in system information.
The UEs 3 choose available resources depending on the ES configuration signalled by the base station 5.
An optional parameter in system information (e.g. minimum system information, such as MIB or SIB1) indicates whether the UEs 3 should inform the base station 5 whether they support network energy saving.
The UEs 3 report their energy saving capability (if requested via system information).
System information is updated by the base station 5 following ES configuration update (including potential offload of non ES-capable UEs 3 and indication of ES configuration for the remaining UEs 3).

Effectively, the mapping information or parameter transmitted to the UE 3 may be referred to as first information identifying the energy saving configuration applied by the access network node (in this case the base station 5). The mapping for the energy saving configuration indicates, for each one of a plurality of blocks of consecutive subframes within a period (e.g. using one bit per five subframes in a 160 ms period), whether the energy saving operation is applied by the access network node for that block of consecutive subframes. The an indication of the affected functionalities may be referred to as second information identifying at least one functionality affected by the energy saving operation. The UE's energy saving capability may be referred to as third information identifying a capability of the UE to support the energy saving configuration.

Beneficially, using the above approach, it is possible to provide a dynamic energy saving pattern with fine granularity where the network (base station 5) can adapt its operation to current load conditions without necessarily completely shutting down and without having to offload UEs 3 to neighbouring cells. This is possible because the ES configuration includes information identifying the on/off pattern of the cell 6 (i.e. the ‘first information’).

The above approach allows configuring non dedicated resources (such as broadcast and PRACH) only when dedicated resources are being configured as well, which pattern is load- and latency-dependent and the cell 6 can be off the rest of the time.

The energy saving approach is backwards compatible and legacy UEs are still be able to access the cell 6, or they can be redirected if necessary using legacy procedures.

### User Equipment (UE)

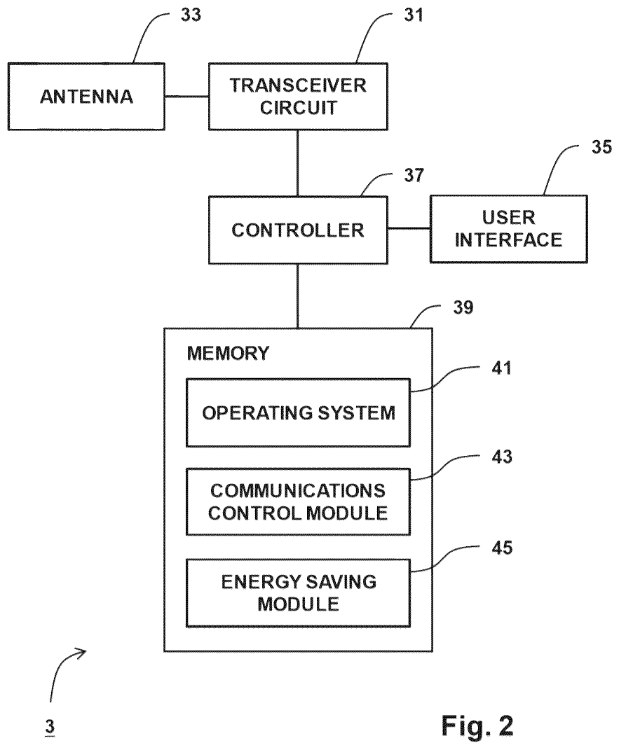

FIG. 2 is a block diagram illustrating the main components of the mobile device (UE) 3 shown in FIG. 1. As shown, the UE 3 includes a transceiver circuit 31 which is operable to transmit signals to and to receive signals from the connected node(s) via one or more antenna 33. Although not necessarily shown in FIG. 2, the UE 3 will of course have all the usual functionality of a conventional mobile device (such as a user interface 35) and this may be provided by any one or any combination of hardware, software and firmware, as appropriate. A controller 37 controls the operation of the UE 3 in accordance with software stored in a memory 39. The software may be pre-installed in the memory 39 and/or may be downloaded via the telecommunication network 1 or from a removable data storage device (RMD), for example. The software includes, among other things, an operating system 41, a communications control module 43, and an energy saving module 45.

The communications control module 43 is responsible for handling (generating/sending/receiving) signalling messages and uplink/downlink data packets between the UE 3 and other nodes, including (R)AN nodes 5 and core network nodes. The signalling may comprise control signalling (e.g. via system information or RRC) related to the energy saving operation. It will be appreciated that the communications control module 43 may include a number of sub-modules (‘layers’ or ‘entities’) to support specific functionalities. For example, the communications control module 43 may include a PHY sub-module, a MAC sub-module, an RLC sub-module, a PDCP sub-module, an SDAP sub-module, an IP sub-module, an RRC sub-module, etc.

The energy saving module 45 is responsible for operations relating to energy saving (by the UE 3 itself and/or by network nodes such as the access network node/base station 5). Energy saving is typically achieved by turning off certain components (e.g. the transceiver circuit 31) for certain periods.

### Access Network Node (Base Station)

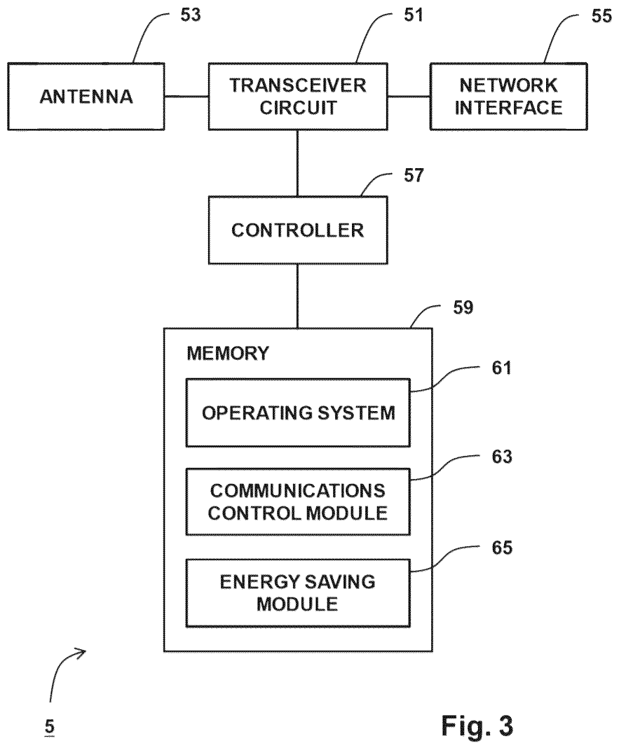

FIG. 3 is a block diagram illustrating the main components of the base station 5 (or a similar access network node) shown in FIG. 1. As shown, the base station 5 includes a transceiver circuit 51 which is operable to transmit signals to and to receive signals from connected UE(s) 3 via one or more antenna 53 and to transmit signals to and to receive signals from other network nodes (either directly or indirectly) via a network interface 55. The network interface 55 typically includes an appropriate base station-base station interface (such as X2/Xn) and an appropriate base station-core network interface (such as S1/N1/N2/N3). A controller 57 controls the operation of the base station 5 in accordance with software stored in a memory 59. The software may be pre-installed in the memory 59 and/or may be downloaded via the telecommunication network 1 or from a removable data storage device (RMD), for example. The software includes, among other things, an operating system 61, a communications control module 63, and an energy saving module 65.

The communications control module 63 is responsible for handling (generating/sending/receiving) signalling between the base station 5 and other nodes, such as the UE 3 and the core network nodes. The signalling may comprise control signalling (e.g. via system information or RRC) related to the energy saving operation. It will be appreciated that the communications control module 63 may include a number of sub-modules (‘layers’ or ‘entities’) to support specific functionalities. For example, the communications control module 63 may include a PHY sub-module, a MAC sub-module, an RLC sub-module, a PDCP sub-module, an SDAP sub-module, an IP sub-module, an RRC sub-module, etc.

The energy saving module 65 is responsible for operations relating to energy saving (by the UE 3 and/or by the access network node/base station 5 itself). Energy saving is typically achieved by turning off certain components (e.g. the transceiver circuit 51) for certain periods. For example, the energy saving module 65 may obtain information relating to the UE's energy saving capability from other nodes.

### Core Network Function

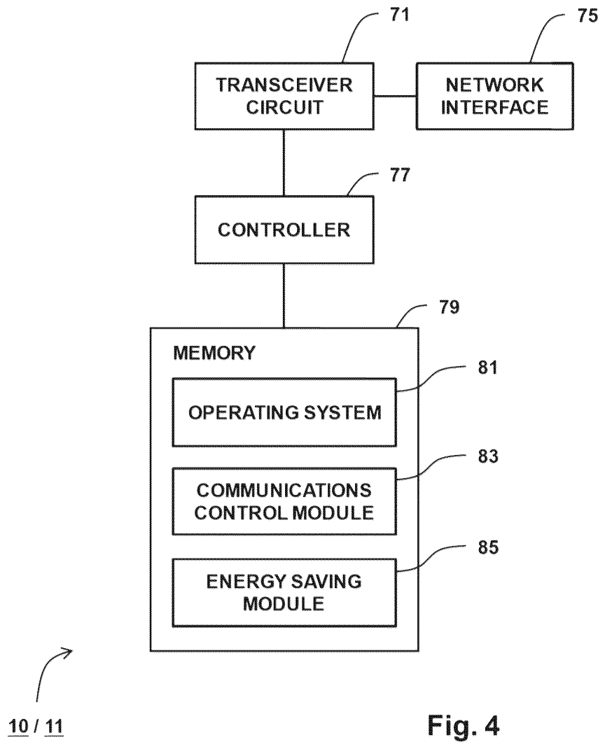

FIG. 4 is a block diagram illustrating the main components of a generic core network function, such as the CPF 10 or the UPF 11 shown in FIG. 1. As shown, the core network function includes a transceiver circuit 71 which is operable to transmit signals to and to receive signals from other nodes (including the UE 3, the base station 5, and other core network nodes) via a network interface 75. A controller 77 controls the operation of the core network function in accordance with software stored in a memory 79. The software may be pre-installed in the memory 79 and/or may be downloaded via the telecommunication network 1 or from a removable data storage device (RMD), for example. The software includes, among other things, an operating system 81, a communications control module 83, and an energy saving module 85 (which may be optional).

The communications control module 83 is responsible for handling (generating/sending/receiving) signalling between the core network function and other nodes, such as the UE 3, the base station 5, and other core network nodes. The signalling may include for example a UE context/UE capability indication of a UE 3 related to energy saving.

If present, the energy saving module 85 is responsible for operations relating to energy saving (e.g. by the UE 3 and/or by the access network node/base station 5). For example, the energy saving module 85 may provide information relating to the UE's energy saving capability to the base station 5.

### DETAILED DESCRIPTION

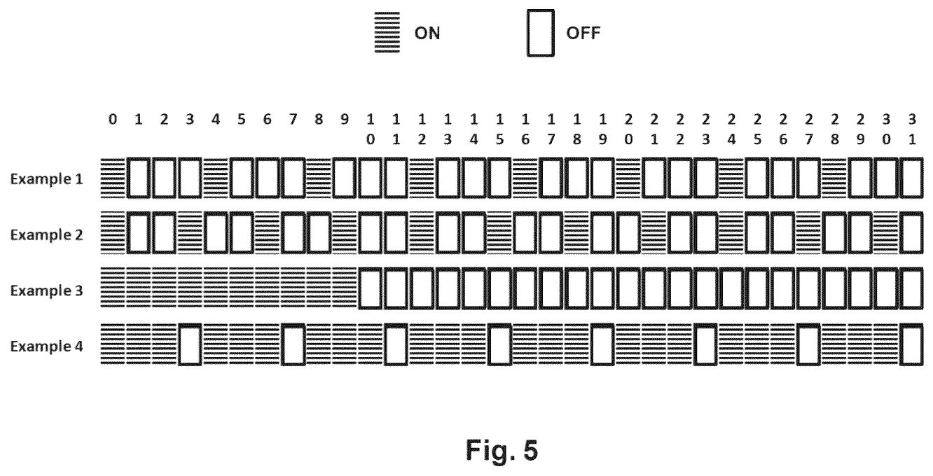

The following is a description of how UE assisted network energy savings may be realised in the system 1 shown in FIG. 1, with reference to FIGS. 5 to 8.

Network load (base station/cell load) may be defined using the following exemplary categories:
Case 1: No active UE (0% load)—in this case the cell could be completely switched off, but some UEs 3 may be camping on it and rely on this cell for future DL/UL data.
Case 2: Few active UEs (5-20% load)—in this case the cell could be switched off and UEs 3 may be offloaded to neighbour cells, but some UEs 3 may require high QoS that is only achievable in this cell.
Case 3: Moderate load (20-50%)—in this case the cell is switched off, if possible, would lead to handover overhead and may not be energy efficient for UEs 3 and network in general. In this case, other methods such as smart scheduling may be more efficient.
Case 4: High but not full load (50-80%)—in this case cell switching off should not be considered. However, the cell is not being utilised to its maximum potential and at least some network energy saving should be achievable.

It will be appreciated that, when using the above definitions, a cell may be considered as having ‘full load’ above 80% (or anywhere between 80% and 100%).

As explained above, using legacy methods the cell 6 is completely switched off, which means that the cell 6 ‘disappears’ completely (e.g. overnight). Accordingly, the UEs 3 must be redirected to another cell 6, and they can return to the cell 6 only via legacy cell reselection when the cell 6 appears again. Legacy methods offer six different configurations for SSS/PSS/MIB. Out of these six possible configurations, one configuration is ‘always on’. Thus, there are only five configurations where, if PRACH and other channels are configured accordingly, the cell 6 can effectively be turned off and consume no power, or be in standby and consume only a relatively low amount of power.

In all cases, it may be beneficial to avoid complete switch-off the cell 6 for a long period of time and to use a relatively finer granularity for cell switch-off. Energy saving should also take into account the load level of the cell 6/base station 5.

Thus, in this system 1, a dynamic cell switch-off approach is used.

In more detail, the base station 5 is ‘switched off’ or in other words not available for reception and transmission for only shorter periods of time, which can be dynamically planned and informed to the UEs 3. The UEs 3 may not be required to leave the cell 6 while it is “switched off” and they can continue using the cell 6 without any specific procedure once the cell 6 is available again.

Furthermore, the base station 5 can decide to only put certain functionalities to sleep but keep others (i.e. it is not required to perform a complete switch-off). The approach can be adapted dynamically depending in traffic load and UE requirements.

Effectively, since it is preferrable to have the whole cell 6 (all relevant functionalities) off at the same time, it is proposed to have a “mask” that can be applied on top of configured resources to indicate if the cell 6 will be receiving/transmitting during designated periods of time. Some examples of these masks are illustrated in FIG. 5.

Nevertheless, the mask (or on/off pattern) can be adapted to be valid only for certain functions. For example, the on/off pattern may be applied to one or more of the following: synchronisation signals, MIB, SIBs, PRACH, configured Physical Uplink Control Channel (PUCCH)/Physical Downlink Control Channel (PDCCH) resources, configured grants and retransmissions, and other configured Physical Downlink Shared Channel (PDSCH)/Physical Uplink Shared Channel (PUSCH) transmissions.

Hence, depending on load conditions and UE requirements, the base station 5 may skip some legacy configured SIBs or PRACH (to achieve some energy saving) or go as far as to cancel some data transmissions for more energy saving (i.e. the cell decides to switch off and UL or DL data is put in buffer).

In order to determine the applicable granularity for the energy saving configuration (on/off pattern), the following issues have been considered.
Regarding the lower bound of applicable granularity:
   PSS/SSS and MIB can be scheduled up to every 5 ms and other channels can be scheduled with a 1 ms granularity.
   From a physical point of view, Power Amplifier ramp up and ramp down can be a limitation, i.e. the cell 6 cannot be switched on/off with too small periodicity.
   A minimum of 5 ms lower bound appears to be sufficient (i.e. half a radio frame).
Regarding the upper bound of applicable granularity:
   PSS/SSS is scheduled at least every 160 ms, if the cell 6 is switched off for a longer period, a legacy neighbouring UE 3 approaching the cell 6 may not be able to detect the cell 6 if it cannot detect a PSS/SSS in this 160 ms interval.
   It appears that a maximum of 160 ms (i.e. 16 radio frames) upper bound is needed for backward compatibility (if backward compatibility is necessary).

However, it will be appreciated that future applications may also go below the proposed 5 ms granularity (e.g. for short transmission time interval applications and/or in Frequency Range 2 applications) or go beyond 160 ms.

FIG. 5 illustrates schematically some exemplary options for achieving energy saving by a base station 5. In this example, the base station 5 is only active for some periods of time, in granularity of five subframes over a 160 ms period, depending on the applicable configuration. Thus, in the example used in FIG. 5, each rectangle represents a group of five subframes.

Striped (groups of) subframes indicate that resources are available if configured by legacy means and the black (groups of) subframes indicate that no resource is available, even if otherwise configured by legacy techniques. When resources are available the cell/base station is ‘ON’, and when no resources are available the cell/base station is effectively ‘OFF’ (at least the components relating to transmission and UE control).

Example 1 of FIG. 5 corresponds to a 20 ms periodicity. However, in this solution, varying loads can be considered with an approximately 3% granularity, for instance ~30% load in Example 2. As can be seen, the periods of activity can be flexible to avoid frequent switching on and off as in Example 3. This solution can also be adapted to network energy savings in case of higher loads (e.g. 75% load) as shown in Example 4.

### Basic Principle

The base station 5 decides to use an energy saving configuration that includes a mapping of on/off times over a repeated period of time, e.g. a 160 ms cycle in this example. For example, the mapping may include, for each group of subframes (e.g. five subframes in FIG. 5), one bit of information indicating whether the cell is on or off during that group of subframes. The one bit of information may be set to a first value (e.g. ‘1’) for those groups of subframes during which network energy saving is turned on (i.e. the cell is turned off) and set to a second value (e.g. ‘0’) for those groups of subframes during which network energy saving is turned off (i.e. the cell is on), or vice versa. It will be appreciated that any other suitable mapping granularity and/or mapping values may be used.

The base station 5 may also provide an indication of which functionalities are switched off (e.g. PRACH, SIBs and retransmissions) whilst network energy saving is on. The base station 5 broadcasts the current energy saving configuration to the UEs 3 in its cell 6.

The UEs 3 may be configured to combine their legacy configuration (e.g. discontinuous reception/transmission and/or configured grant) with the energy saving configuration of the cell 6 to determine the timing of the next available resource in the cell 6.

In this example with a fully flexible 5 ms granularity over 160 ms, 32 bits signalling is necessary. However, as most energy saving configurations may not be practical, and since there are many similar possible patterns, it will be appreciated that fewer bits may be sufficient (e.g. 16 bits).

Legacy resource configuration are only applicable during “on” times, so low periodicity of system information can be applied during these times, e.g. high PRACH configuration but only every fifth set of five subframes. Also, “on” time only determines that a resource can be available, they will only actually be available if they would have been available with legacy configuration (mapping acts as an “AND” function).

However, this solution may not be backward compatible. Legacy UEs 3 (in this case UEs that support an earlier release) will be able to decode normal SI and:
they may not find PSS/SSS that are not sent during off times and think they lost the cell; and/or
they may use RACH during off times and “fail” (the base station 5 is not listening so there is no random access response), leading to unnecessary and potentially interfering power ramp up.

To make this solution backward compatible, the following two options are suggested:
Only apply energy saving configurations in specific bandwidth parts where the network knows the UEs 3 support network energy saving. This option has the advantage of being easy to implement but the energy saving gains may be limited as a backward compatible initial bandwidth part will not be implementing finer network energy saving techniques.
Have the cell go to legacy sleep and apply handover to legacy UEs 3 while keeping energy saving capable UEs 3 in the cell. This option would allow full potential of network energy saving but there may be interference issues for UEs 3 close to the (still partially on) cell that were handed over to a neighbour cell.

### Solution 1

This solution is a practical implementation of the high-level solution described above. The base station 5 is only active for periods of time (applicable to every BWP in the cell 6), and the energy saving configuration is signalled in system information. However, the energy saving configuration may be an optional parameter, as the base station 5 may act as a legacy base station or it may not be in energy saving mode in some scenarios (in which case it is not necessary to transmit any energy saving related information).

The UEs 3 acquire information identifying the on/off times (energy saving configuration) before they perform initial access so that the UEs 3 know where system information and RACH resources are available. Preferably, this information is provided in the cell 6 as part of the minimal system information (MIB or SIB1). The UE 3 behaviour for system information monitoring and RACH resource selection is based on this information.

After initial access, the UEs 3 can be made aware of any energy saving configuration update by either updating the system information or by transmitting the updated energy saving configuration to the UEs 3 using higher layer signalling (e.g. RRC).

Note that this approach can also be implemented for legacy UEs 3 if the cell 6 uses legacy switch-off techniques (including handover) for legacy UEs 3, while being in the above described pattern-based energy saving mode for compatible UEs 3 (e.g. Release 18 UEs and later).

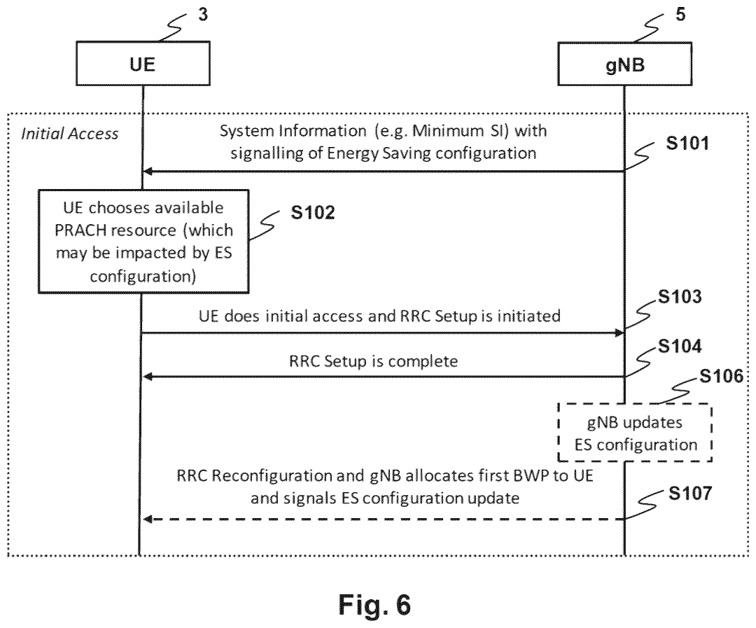

FIG. 6 illustrates the overall procedure for network energy saving according to Solution 1. As generally shown in step S101, the applicable network energy saving configuration (ES configuration) is indicated via system information, for example minimum system information.

In step S102, the UE 3 (in this case a UE that is compatible with this ES configuration) choses an available PRACH resource based on the energy saving configuration and proceeds to perform initial access/RRC setup, in step S103. The network/base station 5 confirms that RRC setup is complete in step S104. From this point, the UE 3 and the base station 5 use the energy saving configuration that has been indicated in step S101.

As generally shown in steps S106 and S107, the base station 5 may update the energy saving configuration applied in its cell 6 indicate the updated energy saving configuration to the UE 3 using an appropriately formatted RRC message (e.g. an RRC Reconfiguration or an RRC Connection Reconfiguration message). The updated energy saving configuration may be included in for example in the RRC message that allocates a bandwidth part (e.g. the first bandwidth part) to the UE 3. It will be appreciated that such an update of the energy saving configuration may be triggered by the arrival/initial access of the UE 3 in the cell 6 (or the subsequent arrival of another UE). The update may relate to at least one of the mapping/granularity used in the cell 6 and the affected functionalities.

Although not shown in FIG. 6, the updated energy saving configuration may also be broadcast via system information so that new UEs can reach the cell 6 based on the updated configuration (and existing UEs can update their operation accordingly).

### Solution 2

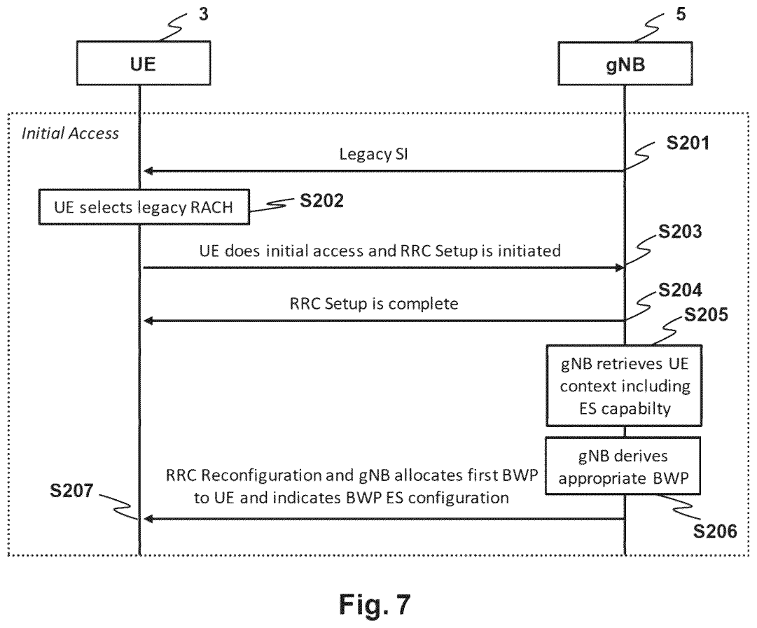

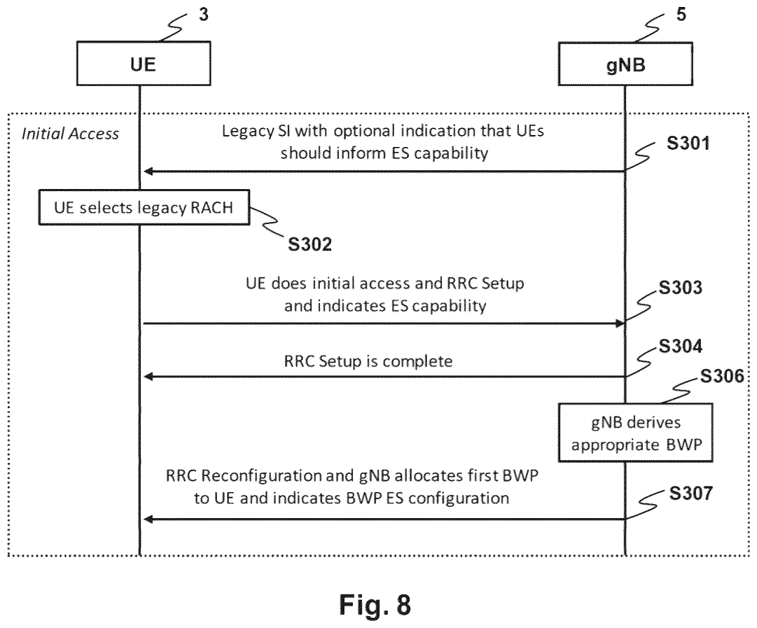

This is effectively the same as Solution 1 but it is implemented per bandwidth part to improve backwards compatibility and to allow potentially longer off periods than 160 ms. Two exemplary implementations of this solution are illustrated in FIG. 7 and FIG. 8.

An initial bandwidth part is used for every UE 3, with typically legacy energy saving tools (apart from a complete switch-off) implemented on this bandwidth part. Thus, the UEs 3 may be configured to perform legacy initial access procedures (i.e. in this initial bandwidth part all resources are available so the UEs 3 do not have to apply a mask/pattern at this stage). In this solution, information identifying the applicable energy saving configuration is provided by the base station 5 during RRC reconfiguration when the first bandwidth part is allocated to the UE 3.

In this case, the network needs to know whether the UE 3 is energy saving capable or not to avoid allocating the UE 3 to a bandwidth part that has an incompatible energy saving configuration.

A first variation of Solution 2 is shown in FIG. 7.

As can be seen, the base station 5 broadcast legacy system information in step S201, i.e. the system information does not include any information relating to network energy saving (or such information may be ignored by the UE 3). Thus, the UE 3 selects random access channel resources using legacy methods (step S202), and proceeds to perform legacy initial access and RRC setup procedures (step S203), followed by a confirmation from the network that RRC setup is complete (step S204).

Beneficially, base station 5 can determine whether the UE 3 supports network energy saving from the UE context associated with the UE 3. Note: the UE's energy saving capability forms part of the UE Context.

For example, the base station 5 may be configured to perform any of the following procedures (as generally illustrated in step S205):
1) obtain the UE's energy saving capability from a core network node (e.g. AMF) using a ‘UE Context Request’ procedure (3GPP TS 38.413);
2) obtain the UE's energy saving capability from a neighbouring base station 5 using a ‘Retrieve UE Context’ procedure (3GPP TS 38.423);
3) obtain the UE's energy saving capability from the UE 3 itself using a ‘UECapability Enquiry’ procedure (3GPP TS 38.331).

It will be appreciated that in case of option 2), the base station 5 may be configured to explicitly ask for the UE's energy saving capability since the ‘UE Radio Capability ID’ field is optional in the Retrieve UE Context Response.

Based on the UE's capability (i.e. whether or not the UE 3 supports the energy saving employed by the base station 5), the base station 5 proceeds to allocate an appropriate bandwidth part (BWP) to the UE 3, in step S206. It will be appreciated that step S206 may also involve updating the energy saving configuration applied in its cell 6, as described above with reference to steps S106 and S107.

Once the appropriate bandwidth part has been allocated, the base station 5 indicates the energy saving configuration to the UE 3 using an appropriately formatted RRC message that allocates the bandwidth part to the UE 3 (e.g. an RRC Reconfiguration or an RRC Connection Reconfiguration message). It will be appreciated that the base station 5 may indicate a new energy saving configuration to the UE 3 whenever it is necessary to update the configuration used in the cell 6 or the bandwidth part used by the UE 3 (e.g. by repeating steps S206 and S207).

A second variation of Solution 2 is shown in FIG. 8. In this case, the UE 3 informs the network (base station 5) before allocation of the first bandwidth part.

As generally shown in step S301, the base station 5 broadcast system information which may include information (e.g. a flag) indicating that the UEs 3 need to provide information regarding their relating to support network energy saving.

In this example, the UE 3 performs legacy RACH procedures (step S302) and indicates its energy saving capability during initial access/RRC setup (step S303). It will be appreciated that if the system information does not request the UE 3 to indicate its energy saving capability (or if the UE 3 does not indicate its capability in response to the system information), the base station 5 may use the UECapabilityEnquiry procedure to obtain the energy saving capability information from the UE 3 (during or after initial access).

Steps S306 and S307 are the same as steps S206 and S207, respectively.

It will be appreciated that solution 2 is compatible with the scenario where the base station 5 chooses to offload non energy saving capable UEs 3 and reserves the cell for energy saving capable UEs 3 (similarly to Solution 1).

Beneficially, this approach is backwards compatible. It also offers a finer granularity than existing energy saving methods, and it can adapted to any UE 3 during connection phase (e.g. still serve power users in dedicated BWPs).

### Modifications and Alternatives

Detailed embodiments have been described above. As those skilled in the art will appreciate, a number of modifications and alternatives can be made to the above embodiments whilst still benefiting from the disclosures embodied therein. By way of illustration only a number of these alternatives and modifications will now be described.

It will be appreciated that the above embodiments may be applied to both 5G New Radio and LTE systems (E-UTRAN). The above embodiments may also be applied to future systems (beyond 5G, 6G, etc.).

The next-generation mobile networks support diversified service requirements, which have been classified into three categories by the International Telecommunication Union (ITU): Enhanced Mobile Broadband (eMBB); Ultra-Reliable and Low-Latency Communications (URLLC); and Massive Machine Type Communications (mMTC). eMBB aims to provide enhanced support of conventional mobile broadband, with focus on services requiring large and guaranteed bandwidth such as High Definition (HD) video, Virtual Reality (VR), and Augmented Reality (AR). URLLC is a requirement for critical applications such as automated driving and factory automation, which require guaranteed access within a very short time. MMTC needs to support massive number of connected devices such as smart metering and environment monitoring but can usually tolerate certain access delay. It will be appreciated that some of these applications may have relatively lenient Quality of Service/Quality of Experience (QoS/QoE) requirements, while some applications may have relatively stringent QoS/QoE requirements (e.g. high bandwidth and/or low latency). It will be appreciated that the energy saving methods described in this document may be applicable to at least one of the above categories of UEs and/or at least one type of services. Different energy saving approach (if any) may be applicable to different categories of UEs and/or different services.

In the above description, the UE, the access network node (base station), and the core network node are described for ease of understanding as having a number of discrete modules (such as the communication control modules). Whilst these modules may be provided in this way for certain applications, for example where an existing system has been modified to implement the disclosure, in other applications, for example in systems designed with the inventive features in mind from the outset, these modules may be built into the overall operating system or code and so these modules may not be discernible as discrete entities. These modules may also be implemented in software, hardware, firmware or a mix of these.

Each controller may comprise any suitable form of processing circuitry including (but not limited to), for example: one or more hardware implemented computer processors; microprocessors; central processing units (CPUs); arithmetic logic units (ALUs); input/output (IO) circuits; internal memories/caches (program and/or data); processing registers; communication buses (e.g. control, data and/or address buses); direct memory access (DMA) functions; hardware or software implemented counters, pointers and/or timers; and/or the like.

In the above embodiments, a number of software modules were described. As those skilled in the art will appreciate, the software modules may be provided in compiled or un-compiled form and may be supplied to the UE, the access network node (base station), and the core network node as a signal over a computer network, or on a recording medium. Further, the functionality performed by part or all of this software may be performed using one or more dedicated hardware circuits. However, the use of software modules is preferred as it facilitates the updating of the UE, the access network node, and the core network node in order to update their functionalities.

It will be appreciated that the functionality of a base station (referred to as a ‘distributed’ base station or gNB) may be split between one or more distributed units (DUs) and a central unit (CU) with a CU typically performing higher level functions and communication with the next generation core and with the DU performing lower level functions and communication over an air interface with UEs in the vicinity (i.e. in a cell operated by the gNB). A distributed gNB includes the following functional units:

gNB Central Unit (gNB-CU): a logical node hosting Radio Resource Control (RRC), Service Data Adaptation Protocol (SDAP) and Packet Data Convergence Protocol (PDCP) layers of the gNB (or RRC and PDCP layers of an en-gNB) that controls the operation of one or more gNB-DUs. The gNB-CU terminates the so-called F1 interface connected with the gNB-DU.

gNB Distributed Unit (gNB-DU): a logical node hosting Radio Link Control (RLC), Medium Access Control (MAC) and Physical (PHY) layers of the gNB or en-gNB, and its operation is partly controlled by gNB-CU. One gNB-DU supports one or multiple cells. One cell is supported by only one gNB-DU. The gNB-DU terminates the F1 interface connected with the gNB-CU.

gNB-CU-Control Plane (gNB-CU-CP): a logical node hosting the RRC and the control plane part of the PDCP protocol of the gNB-CU for an en-gNB or a gNB. The gNB-CU-CP terminates the so-called E1 interface connected with the gNB-CU-UP and the F1-C (F1 control plane) interface connected with the gNB-DU.

gNB-CU-User Plane (gNB-CU-UP): a logical node hosting the user plane part of the PDCP protocol of the gNB-CU for an en-gNB, and the user plane part of the PDCP protocol and the SDAP protocol of the gNB-CU for a gNB. The gNB-CU-UP terminates the E1 interface connected with the gNB-CU-CP and the F1-U (F1 user plane) interface connected with the gNB-DU.

It will be appreciated that when a distributed base station or a similar control plane-user plane (CP-UP) split is employed, the base station may be split into separate control-plane and user-plane entities, each of which may include an associated transceiver circuit, antenna, network interface, controller, memory, operating system, and communications control module. When the base station comprises a distributed base station, the network interface (reference numeral 55 in FIG. 3) also includes an E1 interface and an F1 interface (F1-C for the control plane and F1-U for the user plane) to communicate signals between respective functions of the distributed base station. In this case, the communications control module is also responsible for communications (generating, sending, and receiving signalling messages) between the control-plane and user-plane parts of the base station. It will be appreciated that when a distributed base station is used there is no need to involve both the control-plane and user-plane parts for pre-emption of communication resources as described in the above exemplary embodiments. It will be appreciated that pre-emption may be handled by the user-plane part of the base station without involving the control-plane part (or vice versa).

The above embodiments are also applicable to ‘non-mobile’ or generally stationary user equipment. The above described mobile device may comprise an MTC/IoT device and/or the like.

The User Equipment (or “UE”, “mobile station”, “mobile device” or “wireless device”) in the present disclosure is an entity connected to a network via a wireless interface.

It should be noted that the present disclosure is not limited to a dedicated communication device, and can be applied to any device having a communication function as explained in the following paragraphs.

The terms “User Equipment” or “UE” (as the term is used by 3GPP), “mobile station”, “mobile device”, and “wireless device” are generally intended to be synonymous with one another, and include standalone mobile stations, such as terminals, cell phones, smart phones, tablets, cellular IoT devices, IoT devices, and machinery. It will be appreciated that the terms “mobile station” and “mobile device” also encompass devices that remain stationary for a long period of time.

A UE may, for example, be an item of equipment for production or manufacture and/or an item of energy related machinery (for example equipment or machinery such as: boilers; engines; turbines; solar panels; wind turbines; hydroelectric generators; thermal power generators; nuclear electricity generators; batteries; nuclear systems and/or associated equipment; heavy electrical machinery; pumps including vacuum pumps; compressors; fans; blowers; oil hydraulic equipment; pneumatic equipment; metal working machinery; manipulators; robots and/or their application systems; tools; molds or dies; rolls; conveying equipment; elevating equipment; materials handling equipment; textile machinery; sewing machines; printing and/or related machinery; paper converting machinery; chemical machinery; mining and/or construction machinery and/or related equipment; machinery and/or implements for agriculture, forestry and/or fisheries; safety and/or environment preservation equipment; tractors; precision bearings; chains; gears; power transmission equipment; lubricating equipment; valves; pipe fittings; and/or application systems for any of the previously mentioned equipment or machinery etc.).

A UE may, for example, be an item of transport equipment (for example transport equipment such as: rolling stocks; motor vehicles; motor cycles; bicycles; trains; buses; carts; rickshaws; ships and other watercraft; aircraft; rockets; satellites; drones; balloons etc.).

A UE may, for example, be an item of information and communication equipment (for example information and communication equipment such as: electronic computer and related equipment; communication and related equipment; electronic components etc.).

A UE may, for example, be a refrigerating machine, a refrigerating machine applied product, an item of trade and/or service industry equipment, a vending machine, an automatic service machine, an office machine or equipment, a consumer electronic and electronic appliance (for example a consumer electronic appliance such as: audio equipment; video equipment; a loud speaker; a radio; a television; a microwave oven; a rice cooker; a coffee machine; a dishwasher; a washing machine; a dryer; an electronic fan or related appliance; a cleaner etc.).

A UE may, for example, be an electrical application system or equipment (for example an electrical application system or equipment such as: an x-ray system; a particle accelerator; radio isotope equipment; sonic equipment; electromagnetic application equipment; electronic power application equipment etc.).

A UE may, for example, be an electronic lamp, a luminaire, a measuring instrument, an analyzer, a tester, or a surveying or sensing instrument (for example a surveying or sensing instrument such as: a smoke alarm; a human alarm sensor; a motion sensor; a wireless tag etc.), a watch or clock, a laboratory instrument, optical apparatus, medical equipment and/or system, a weapon, an item of cutlery, a hand tool, or the like.

A UE may, for example, be a wireless-equipped personal digital assistant or related equipment (such as a wireless card or module designed for attachment to or for insertion into another electronic device (for example a personal computer, electrical measuring machine)).

A UE may be a device or a part of a system that provides applications, services, and solutions described below, as to ‘internet of things’ (IoT), using a variety of wired and/or wireless communication technologies.

Internet of Things devices (or “things”) may be equipped with appropriate electronics, software, sensors, network connectivity, and/or the like, which enable these devices to collect and exchange data with each other and with other communication devices. IoT devices may comprise automated equipment that follow software instructions stored in an internal memory. IoT devices may operate without requiring human supervision or interaction. IoT devices might also remain stationary and/or inactive for a long period of time. IoT devices may be implemented as a part of a (generally) stationary apparatus. IoT devices may also be embedded in non-stationary apparatus (e.g. vehicles) or attached to animals or persons to be monitored/tracked.

It will be appreciated that IoT technology can be implemented on any communication devices that can connect to a communications network for sending/receiving data, regardless of whether such communication devices are controlled by human input or software instructions stored in memory.

It will be appreciated that IoT devices are sometimes also referred to as Machine-Type Communication (MTC) devices or Machine-to-Machine (M2M) communication devices. It will be appreciated that a UE may support one or more IoT or MTC applications. Some examples of MTC applications are listed in the following table (source: 3GPP TS 22.368 V13.1.0, Annex B, the contents of which are incorporated herein by reference). This list is not exhaustive and is intended to be indicative of some examples of machine type communication applications.

| Service Area | MTC applications |
|---|---|
| Security | Surveillance systems |
| | Backup for landline |
| | Control of physical access |
| | (e.g. to buildings) |
| | Car/driver security |
| Tracking & Tracing | Fleet Management |
| | Order Management |
| | Pay as you drive |
| | Asset Tracking |
| | Navigation |
| | Traffic information |
| | Road tolling |
| | Road traffic optimisation/ |
| | steering |
| Payment | Point of sales |
| | Vending machines |
| | Gaming machines |
| Health | Monitoring vital signs |
| | Supporting the aged or |
| | handicapped |
| | Web Access Telemedicine |
| | points |
| | Remote diagnostics |
| Remote Maintenance/ | Sensors |
| Control | Lighting |
| | Pumps |
| | Valves |
| | Elevator control |
| | Vending machine control |
| | Vehicle diagnostics |
| Metering | Power |
| | Gas |
| | Water |
| | Heating |
| | Grid control |
| | Industrial metering |
| Consumer Devices | Digital photo frame |
| | Digital camera |
| | eBook |

Applications, services, and solutions may be an Mobile Virtual Network Operator (MVNO) service, an emergency radio communication system, a Private Branch exchange (PBX) system, a PHS/Digital Cordless Telecommunications system, a Point of sale (POS) system, an advertise calling system, a Multimedia Broadcast and Multicast Service (MBMS), a Vehicle to Everything (V2X) system, a train radio system, a location related service, a Disaster/Emergency Wireless Communication Service, a community service, a video streaming service, a femto cell application service, a Voice over LTE (VoLTE) service, a charging service, a radio on demand service, a roaming service, an activity monitoring service, a telecom carrier/communication NW selection service, a functional restriction service, a Proof of Concept (PoC) service, a personal information management service, an ad-hoc network/Delay Tolerant Networking (DTN) service, etc.

Further, the above-described UE categories are merely examples of applications of the technical ideas and exemplary embodiments described in the present document. Needless to say, these technical ideas and embodiments are not limited to the above-described UE and various modifications can be made thereto.

The method performed by the access network node may further comprise transmitting second information identifying at least one functionality affected by the energy saving operation. The at least one functionality may include at least one of: transmission of synchronisation signals; transmission of a master information block; transmission of at least one system information block; configured grant functionality; scheduled Physical Downlink Shared Channel (PDSCH)/Physical Uplink Shared Channel (PUSCH) transmissions; a Physical Random Access Channel (PRACH) functionality; and retransmission functionality.

At least one of the first information and the second information may be transmitted via system information.

At least one of the first information and the second information may be transmitted using a radio resource control (RRC) signalling.

At least one of the first information and the second information may be transmitted using an RRC message for allocating a bandwidth part to the UE.

The method performed by the access network node may further comprise obtaining third information identifying a capability of the UE to support an energy saving configuration. The third information may be included in a UE context associated with the UE.

The third information may be obtained from a core network node for mobility management (e.g. an AMF). For example, the obtaining the third information may include obtaining the third information during a UE Context Request procedure.

The third information may be obtained from another access network node. For example, the obtaining the third information may include obtaining the third information during a UE Context Transfer procedure.

The third information may be obtained from the UE. For example, the obtaining the third information may include obtaining the third information during initial access/RRC setup.

The method performed by the access network node may further comprise allocating a bandwidth part to the UE in a case that the UE supports the energy saving configuration based on the third information.

The method performed by the access network node may further comprise initiating a handover procedure for the UE in a case that the UE does not support the energy saving configuration.

The energy saving configuration may be applied by the access network node per cell or per bandwidth part.

The method performed by the UE may further comprise: configuring the UE for communicating with the access network node according to a UE specific configuration; and communicating with the access network node according to the UE specific configuration by taking into account the energy saving configuration applied by the access network node.

The method performed by the UE may further comprise determining at least one subframe in which the energy saving operation is not applied by the access network node.

Various other modifications will be apparent to those skilled in the art and will not be described in further detail here.

For example, the whole or part of the exemplary embodiments disclosed above can be described as, but not limited to, the following supplementary notes.

### (Supplementary Note 1)

A method performed by an access network node, the method comprising:
transmitting, to a user equipment (UE), first information indicating, for each one of a plurality of blocks of consecutive subframes within a period, whether an energy saving operation is applied by the access network node for the one of the plurality of blocks of the consecutive subframes.

### (Supplementary Note 2)

The method according to supplementary note 1, further comprising transmitting second information identifying at least one functionality affected by the energy saving operation.

### (Supplementary Note 3)

The method according to supplementary note 2, wherein the at least one functionality includes at least one of:
transmission of synchronisation signals;
transmission of a master information block;
transmission of at least one system information block;
configured grant functionality;
scheduled Physical Downlink Shared Channel (PDSCH)/Physical Uplink Shared Channel (PUSCH) transmissions;
a Physical Random Access Channel (PRACH) functionality; and
retransmission functionality.

### (Supplementary Note 4)

The method according to supplementary note 2 or 3, wherein at least one of the first information and the second information is transmitted via system information.

### (Supplementary Note 5)

The method according to any of supplementary notes 2 to 4, wherein at least one of the first information and the second information is transmitted using a radio resource control (RRC) signalling.

### (Supplementary Note 6)

The method according to any of supplementary notes 2 to 5, wherein at least one of the first information and the second information is transmitted using an RRC message for allocating a bandwidth part to the UE.

### (Supplementary Note 7)

The method according to any of supplementary notes 1 to 6, further comprising obtaining third information identifying a capability of the UE to support an energy saving configuration.

### (Supplementary Note 8)

The method according to supplementary note 7, wherein the third information is included in a UE context associated with the UE.

### (Supplementary Note 9)

The method according to supplementary note 7 or 8, wherein the third information is obtained from a core network node for mobility management.

### (Supplementary Note 10)

The method according to supplementary note 9, wherein the third information is obtained during a UE Context Request procedure.

### (Supplementary Note 11)

The method according to supplementary note 7 or 8, wherein the third information is obtained from another access network node.

### (Supplementary Note 12)

The method according to supplementary note 11, wherein the third information is obtained during a UE Context Transfer procedure.

### (Supplementary Note 13)

The method according to supplementary note 7 or 8, wherein the third information is obtained from the UE.

### (Supplementary Note 14)

The method according to supplementary note 13, wherein the third information is obtained during initial access/RRC setup.

### (Supplementary Note 15)

The method according to any of supplementary notes 7 to 14, further comprising allocating a bandwidth part to the UE in a case that the UE supports the energy saving configuration based on the third information.

### (Supplementary Note 16)

The method according to any of supplementary notes 1 to 15, further comprising initiating a handover procedure for the UE in a case that the UE does not support the energy saving configuration.

### (Supplementary Note 17)

The method according to any of supplementary notes 1 to 16, wherein the energy saving configuration applied by the access network node is applied per cell or per bandwidth part.

### (Supplementary Note 18)

A method performed by a user equipment (UE), the method comprising: receiving, form an access network node, first information indicating, for each one of a plurality of blocks of consecutive subframes within a period, whether an energy saving operation is applied by the access network node for the one of the plurality of blocks of the consecutive subframes.

### (Supplementary Note 19)

The method according to supplementary note 18, further comprising: configuring the UE for communicating with the access network node according to a UE specific configuration; and communicating with the access network node according to the UE specific configuration by taking into account the energy saving configuration applied by the access network node.

### (Supplementary Note 20)

The method according to supplementary note 18 or 19, further comprising determining at least one subframe in which the energy saving operation is not applied by the access network node.

### (Supplementary Note 21)

An access network node comprising:
means for transmitting, to a user equipment (UE), first information indicating, for each one of a plurality of blocks of consecutive subframes within a period, whether an energy saving operation is applied by the access network node for the one of the plurality of blocks of the consecutive subframes.

### (Supplementary Note 22)

A user equipment (UE) comprising:
means for receiving, form an access network node, first information indicating, for each one of a plurality of blocks of consecutive subframes within a period, whether an energy saving operation is applied by the access network node for the one of the plurality of blocks of the consecutive subframes.

This application is based upon and claims the benefit of priority from Great Britain Patent Application No. 2206088.3, filed on Apr. 26, 2022, the disclosure of which is incorporated herein in its entirety by reference.

### REFERENCE SIGNS LIST

1 TELECOMMUNICATION SYSTEM
3 MOBILE DEVICE
5 BASE STATION
7 CORE NETWORK
10 CONTROL PLANE FUNCTIONS
11 USER PLANE FUNCTIONS
20 DATA NETWORK
31 TRANSCEIVER CIRCUIT
33 ANTENNA
35 USER INTERFACE
37 CONTROLLER
39 MEMORY
41 OPERATING SYSTEM
43 COMMUNICATIONS CONTROL MODULE
45 ENERGY SAVING MODULE
51 TRANSCEIVER CIRCUIT
53 ANTENNA
55 NETWORK INTERFACE
57 CONTROLLER
59 MEMORY
61 OPERATING SYSTEM
63 COMMUNICATIONS CONTROL MODULE
65 ENERGY SAVING MODULE
71 TRANSCEIVER CIRCUIT
75 NETWORK INTERFACE
77 CONTROLLER
79 MEMORY
81 OPERATING SYSTEM
83 COMMUNICATIONS CONTROL MODULE
85 ENERGY SAVING MODULE

What is claimed is:

1. A method performed by an access network node, the method comprising:
transmitting, to a user equipment (UE), a Radio Resource Control (RRC) Reconfiguration message including first information indicating, within a period, on-duration time during which an energy saving operation at the access network node has been activated.

2. The method according to claim 1, further comprising:
transmitting, to the UE, a UE capability enquiry message; and
receiving, from the UE, UE capability information for the energy saving operation at the access network node, based on the UE capability enquiry message.

3. The method according to claim 2, further comprising:
transmitting, to the UE, system information indicating change of configuration for the energy saving operation at the access network node, and
wherein the UE uses the system information for updating related to the energy saving operation at the access network node.

4. The method according to claim 1, wherein at least one of:
transmission of synchronisation signals;
transmission of a master information block;
transmission of at least one system information block;
configured grant functionality;
scheduled Physical Downlink Shared Channel (PDSCH)/Physical Uplink Shared Channel (PUSCH) transmissions;
a Physical Random Access Channel (PRACH) functionality; and
retransmission functionality,
is affected by the energy saving operation at the access network node.

5-7. (canceled)

8. The method according to claim 1, wherein the energy saving operation at the access network node is applied per cell or per bandwidth part.

9. The method according to claim 2, further comprising:
determining whether the UE should be handovered to another access network node based on the UE capability information.

10. The method according to claim 9, further comprising allocating a bandwidth part to the UE in a case that the UE supports the energy saving operation at the access network node.

11. The method according to claim 9, further comprising initiating a handover procedure for the UE in a case that the UE does not support the energy saving operation at the access network node.

12-18. (canceled)

19. The method according to claim 1, wherein the first information is determined based on at least one of:
a load at the access network node; and
a latency per service served by the access network node.

20. The method according to claim 1, wherein the first information includes pattern information applied per the period.

21-22. (canceled)

23. A method performed by a user equipment (UE), the method comprising:
receiving, form an access network node, a Radio Resource Control (RRC) Reconfiguration message including first information indicating, within a period, on-duration time during which an energy saving operation at the access network node has been activated; and
configuring the UE with the first information, on the energy saving operation at the access network node.

24-40. (canceled)

41. An access network node comprising:
at least one memory storing instructions; and
at least one processor executing the instructions to:
transmit, to a user equipment (UE), a Radio Resource Control (RRC) Reconfiguration message including first information indicating, for each one of a plurality of blocks of consecutive subframes within a period, on-duration time during which an energy saving operation at the access network node has been activated.

42. A user equipment (UE) comprising:
at least one memory storing instructions; and
at least one processor executing the instructions to:
receive, from an access network node, a Radio Resource Control (RRC) Reconfiguration message including first information indicating, within a period, on-duration time during which an energy saving operation at the access network node has been activated; and
configure the UE with the first information, on the energy saving operation at the access network node.
